(19) United States
(12) Patent Application Publication
(10) Pub. No.: US 2021/0081177 A1
(43) Pub. Date: Mar. 18, 2021

(54) PHYSICAL-EVENT-BASED, RANDOM-NUMBER-GENERATION-AND-USE APPARATUS AND METHOD

(71) Applicant: Adam Anderson, Sandy, UT (US)

(72) Inventor: Adam Anderson, Sandy, UT (US)

(21) Appl. No.: 17/023,541

(22) Filed: Sep. 17, 2020

Related U.S. Application Data
(60) Provisional application No. 62/902,191, filed on Sep. 18, 2019.

(51) Int. Cl. G06F 7/58; A63F 9/18

(52) U.S. Cl. CPC G06F 7/588; G06F 9/445; A63F 9/183; A63F 9/181

(57) ABSTRACT

Unpredictable action of a physical device provides a truly random number from a “smart top,” including a spinner, preferably self-centering, such as a segment of a sphere. A housing containing a CPU and memory device is made to rotate in a plane parallel to a supporting surface, that plane containing the maximum moment of inertia of the apparatus. A central axis, located or self-locating, near a center of mass of the apparatus provides a contact “point” (pointed or not), shaped to reduce a moment arm of friction acting on the device when spinning on a rigid surface. Executables (programs) track rotation about the central axis, outputting a corresponding random number to other executables using it to control a meaningful outcome. One embodiment may be implemented in a smart phone equipped with a self-centering spinner.

### RELATED APPLICATIONS

This application claims the benefit of U.S. Provisional Patent Application Ser. No. 62/902,191, filed Sep. 18, 2020, which is hereby incorporated by reference.

### BACKGROUND

### Field of the Invention

This invention relates to spinning tops and, more particularly, to novel systems and methods for smart tops capable of creating physical events that generate and communicate truly random numbers for various uses.

### BACKGROUND ART

Science relies on statistics and probability to characterize events in nature, failures of equipment, and so forth. Likewise, biological sciences rely on statistics and probabilities in populations for purposes of study and prediction of various physical and biological characteristics.

Meanwhile, engineers may rely on statistics and probability as well as more determinative mathematical calculations to make predictions or performance analyses of physical systems, according to their known physical characteristics. Similarly, mathematicians and the entire science of cryptography as well as gaming devices and games rely on certain calculations or predictions of chance (probabilities) combined with strategic use of those probabilities.

Books discussing organized crime such as “Hit Man” by Howie Carr as well as movies and Broadway plays such as “Guys and Dolls” exemplify the virtual addiction to chance and probabilities experienced by many who gamble.

For various endeavors, creation of a random number is required by a computer program. It is well understood by those in the art of probability and statistics, and especially cryptography that a truly random number cannot be created by a computer. Rather, sophisticated algorithms try to create an unpredictable, or more accurately stated “difficult-to-predict,” number starting with a seed value and a sophisticated manipulation routine.

Truly random events may be created in a physical world. Again, perhaps a knowledge and intelligence level of a god would be sufficient to predict any event. However, given the limited knowledge of humans, many events are unpredictable and may therefore be considered truly random.

It would be an advance in the art to provide a simple, portable, readily available random number generator for use in controlling any number of processes. One process readily applicable is the process of providing a random value for a game or a decision.

For example, dice provide two physical devices, each capable of producing one of six values on any roll, and together providing a total of 36 possible combinations, many being duplicates. Many of those combinations result in the same ultimate value from the two dice, which fact therefore changes the probability of the total value between the two dice.

Similarly, pointers, selectors, and the like may be created to provide a number of answers, random selections of persons at a table, or the like. Everything from bingo, spin-the-bottle attempt to select a number at random. It would be an advance in the art to provide a simple, portable, readily-available, physical system that can provide a truly random number into a process.

### BRIEF SUMMARY OF THE INVENTION

A system in accordance with the invention may include an apparatus and a method for generating a genuinely random number based on a physical event that is entirely unpredictable. For example, in one system in accordance with the invention a device including a central processing unit, a computer readable and non-transitory memory device, in or connected to one another within a housing may be capable of rotation in a plane. In certain embodiments, that plane of rotation of the device may be the plane that provides a maximum moment of inertia of the apparatus.

Moment of inertia is an integral of a product of a radius and a differential mass spaced from a center point. Any suitable mathematics book, dictionary, or engineering text will provide a definition, which one may use quite ignorantly, without being a mathematician nor an engineer.

In certain embodiments, a spherical segment (frustum) post, or pin may be located near a center of mass of the apparatus within the plane of rotation. Of course, what is really passing through that plane and normal to that plane is an axis. The axis determines a center of rotation a post or pin about which the apparatus spins.

Thus, having a pin or center of rotation secured to the housing and shaped to reduce the lever (moment) arm of friction acting on the device when spinning, provides a long “comparatively speaking” period of spinning and thus increases the unpredictability of a number of turns, a particular terminal orientation, or the like.

In one currently contemplated embodiment of system in accordance with the invention, a memory device may contain a first executable (program, set of programming instructions, etc.) to be loaded into the CPU and capable of programming the CPU to track rotation of the apparatus about the post.

The result is that several methods are available to calculate or create a random number based on the rotation. For example, the total revolutions, degrees, radians, time, or the like may be used as the basis of a random number. Alternatively, a remainder of degrees, radians, or revolutions may be used after deducting some even number thereof.

The memory device may also be loaded with a second executable that may be loaded in the CPU to effectuate an output as a function of the random number. Thus, for example, a cellphone may be provided with a “spinner” or contact device for spinning, suitable for rendering the phone a “top” such as children play with. Accordingly, the memory device may track the number of rotations, degrees rotated through, radians rotated through, or a remainder number, such as total degrees beyond a total number of complete revolutions, or the like.

That physically random number may then be fed into a program that converts the random number into a selection, pointer, mapped number mapped to the space of the random number, or the like. In this way, an output may be represented in any form desired. It may be a number, a direction, a quadrant, a selection, a pair of dice with a particular number showing, a pointer with a direction showing, or any other selection among a group, which selection is thereby rendered fully, physically, random.

A method for generating a random number relies on a physical “top” device provided with “smart” capability, such as by converting a “smart phone” into a spinning top.

An apparatus may be configured as a device comprising a central processing unit (CPU), a computer readable, non-transitory, memory device operably connected thereto, and a housing containing both and capable of rotation in a plane parallel to a plane of maximum moment of inertia of the apparatus.

A post is located at or near a center of mass of the apparatus, being secured to the housing and shaped to reduce a moment arm of friction acting on the device when positioned on a rigid surface. That is, every contact with the underlying supporting surface by the “post” at any point not on the actual center of rotation results in friction, and that force of friction operates to create a torque. Torque is the force of friction multiplied by the distance, measured from the center of rotation, at which the force acts.

In the memory device, a first executable is loadable into the CPU and capable of programming the CPU to track rotation of the apparatus about the post and to output a random number based on the rotation. A second executable programmable into the CPU executes functions to effectuate an output as a function of that random number.

A fastener is capable of securing the post to the housing. The post may be shaped to present a rounded surface in contact with the supporting surface. The rounded surface is best (easiest to implement and attach, most reliably, least friction, and so forth) if it forms a portion of a sphere of diameter at least as large in diameter as the housing.

The post may be made with a standoff spacing the contact surface (point, rounded surface, or sphere frustum) away from the housing. In some embodiments, the housing comprises a flat surface against which the “post” is secured. The housing may be literally the housing of a cell phone.

The system may be provided in a kit containing an adhesive, instructions, templates, and one or more embodiments of a post to be added separately, as per the aftermarket kit, to a cell phone from another source.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a frontal perspective view of a system (standing) suitable for implementing apparatus, systems, and methods in accordance with the invention to create truly random numbers based on unpredictable physical events;

FIG. 2 is a rear perspective view thereof;

FIG. 3 is a front elevation view thereof;

FIG. 4 is a rear elevation view thereof;

FIG. 5 is a bottom end plan view thereof;

FIG. 6 is a top end plan view thereof;

FIG. 7 is a left side elevation view thereof;

FIG. 8 is a right side elevation view thereof;

FIG. 9, including sub-FIGS. 9A through 9G, are top end views of various types of pins or rotational points and similar devices for minimizing friction and increasing the time and speed of rotation for an apparatus and method in accordance with the invention;

FIG. 10A is a top end elevation view of a system for locating rotational center a point on an apparatus in accordance with the invention laid flat for measuring and marking;

FIG. 10B is a top end elevation view thereof during marking for determining a center of rotation thereof;

FIG. 10C is a top plan view of a paper thereunder having been marked to use as a template for establishing a center of rotation of an apparatus in accordance with the invention;

FIG. 11A illustrates a first folding step for the template of FIG. 10C;

FIG. 11B illustrates a second folding step for the template of FIG. 11A;

FIG. 11C illustrates a front plan view of a template with an intersection line at which a location pin hole is provided;

FIG. 11D illustrates a front plan view of marking a center point on an apparatus through a template in accordance with the invention;

FIG. 12 is a perspective view of one embodiment of a roller square for an alternative method for determining a center point on an apparatus in accordance with the invention;

FIG. 13 is a perspective view from an opposite end of the roller thereof;

FIG. 14A is a side elevation view of an apparatus and method for establishing a center of mass along a longitudinal direction for an apparatus in accordance with the invention;

FIG. 14B is an end elevation view of the same process being used to establish a center of mass line along a lateral or width direction thereof;

FIG. 14C is a plan view of a rear surface of a phone in a process for marking a back face of an apparatus in accordance with the invention using the markings established by the processes of FIGS. 14A and 14B;

FIG. 15 is a schematic block diagram of a process for an alternative determination of location of outer edges of a disc containing a rotational axis or rotational pin, and particularly the narrowest point end thereof for a geometrical or spatial balancing of an apparatus in accordance with the invention;

FIG. 16A is a right side elevation view of a spinning apparatus in accordance with the invention in which a balance sphere as a spinner point is centered very close to a center of area or center of mass of an apparatus in accordance with the invention;

FIG. 16B illustrates a bottom end elevation view when the balance sphere is not exactly centered, and illustrating the system properly operating despite such an error;

FIG. 16C is a right side elevation view of a longitudinal edge of an apparatus in accordance with the invention spinning about other than the expected axis of rotation due to the balance sphere device as a spinning point or spinner accommodating initial imbalance;

FIG. 17 is a schematic block diagram of a process for launching and executing an application suitable for creating a physically randomized random number and applying that number in an application;

FIG. 18 is a schematic block diagram of a process of obtaining a random number by rotating an apparatus in accordance with the invention;

FIG. 19 is a schematic block diagram of a process for stabilizing and presenting an image on a screen of a rotating apparatus in accordance with the invention;

FIG. 20 is a schematic block diagram of a super pixel containing multiple pixels in order to accommodate the limiting time response in a physical device in accordance with the invention;

FIG. 21 is a chart of amplitude against time illustrating a comparison between an analog wave form and a digital wave form for activating pixels in the super pixel image of FIG. 20;

FIG. 22 is a schematic block diagram of an alternative pixel relying on color contributions for individual pixels, which may be used with or without the super pixel concept of FIG. 20;

FIG. 23 is a chart illustrating an amplitude as a function of time with wave forms for activating particular color schemes and pixels in accordance with one embodiment of the invention using an apparatus; and

FIG. 24 is a schematic block diagram of various locations of an apparatus in accordance with the invention, in which are shown the various locations of a particular pixel or super pixel on a screen of a device in accordance with the invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of systems and methods in accordance with the invention. The illustrated embodiments will be best understood by reference to the drawings, wherein like parts are designated by like numerals throughout.

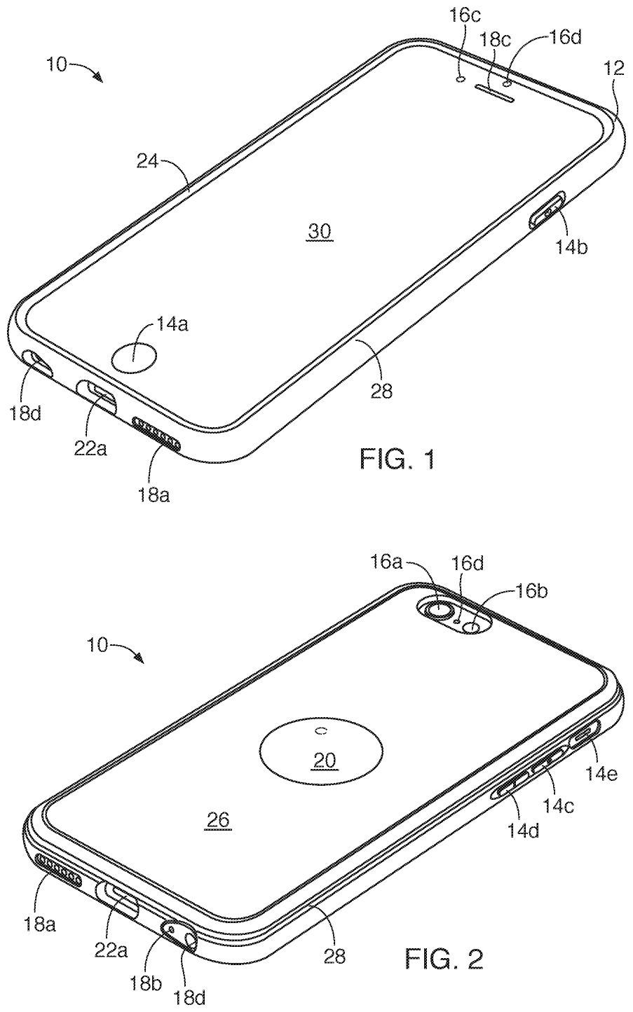

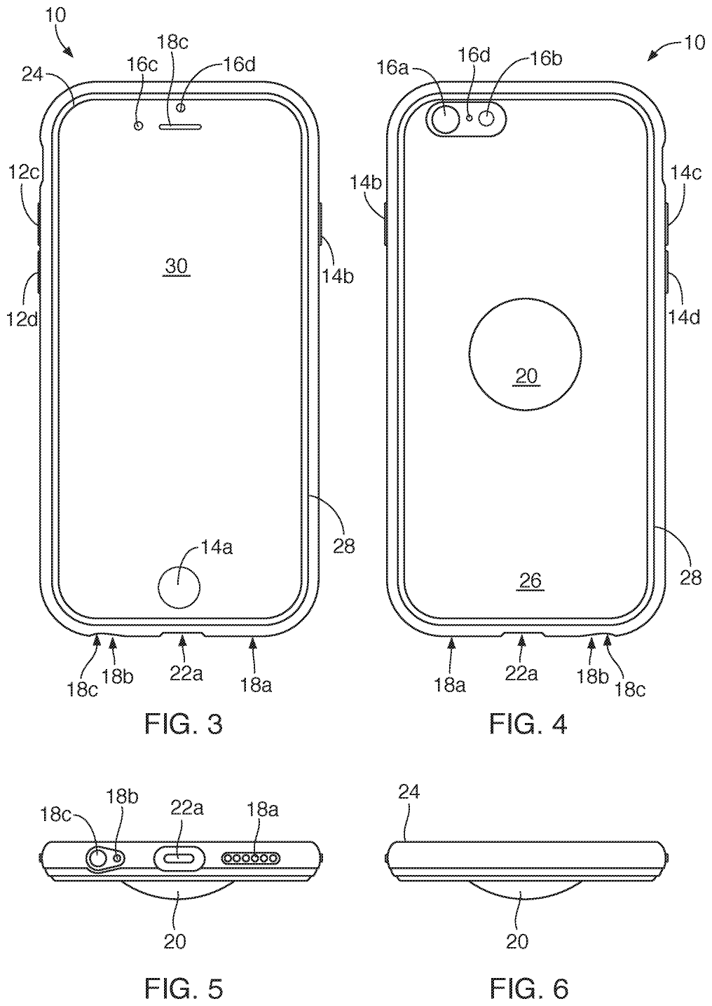

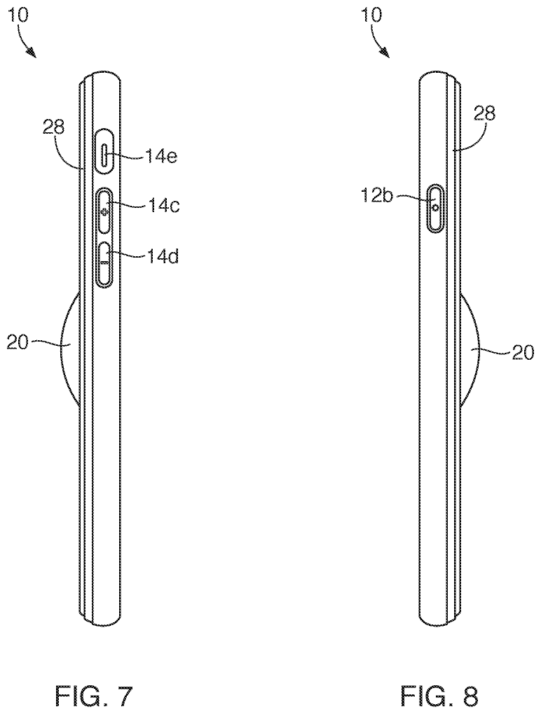

Referring to FIGS. 1 through 8, a system 10 may include a housing 12 such as may be implemented as a cellphone 12. That is, as a practical matter, the content of the system 10 is mainly significant for its computation ability to determine its own orientation, to determine its own rotations, and for its ability to process information. Products such as smart cellphones, personal listening devices such as a player or an iPod™ or the like, and even a compact computing system may be used. As a practical matter, laptop computers and larger computerized units are probably not practical.

In the illustrated embodiment, the housing 12 includes various control buttons 14. For example, control button 14a is a power on button, or may be, a button 14 may be an on-off button. Typically, a button 14c is a volume increase while a button 14d provides a volume decrease. The button 14e may control the audibility or muteness of an alarm thus permitting silencing of audible alarms, rendering them vibratory or other alarms and the like.

Other controls 14b may be used as well for operation of the system 10 and the like. Meanwhile, various “optical” devices 16 may include, for example, a camera 16a, a light 16b, such as a camera flash 16b. An opposite camera lens 16c may be provided as well as sensors 16d for detecting illumination in support of the camera lenses 16a, 16c.

Certain audio devices 18 may include audio speakers 18a, 18c, microphone 18b, connecting jack 18d and so forth.

One novel and nonobvious addition to the system 10 is a spinner 20 or balance structure 20. Typically, that spinner 20 is best served by a balance sphere 20. For example, any phone 12 or housing 12 or any smart (CPU-enabled) device 12 that can be rotated rapidly (comparatively speaking) may have a mass distributed evenly or unevenly. Typically, rotation depends upon the radius of gyration of the mass being a point coincident with a radius of gyration of area.

For example, one may think of all physical items as having a central axis about which all area or all mass is distributed. By integrating with respect to radius a multiplication of each differential area or mass multiplied by its radius from the center point, one may calculate or integrate a moment of area or moment of mass. Accordingly, for a point centric, or axially centric, or axially symmetric body, the mass is balanced about a central axis. For other devices, the actual center of rotation will depend upon the distribution of the masses or areas.

Due to the comparatively compact structure of phones 12, their mass is more-or-less equally distributed. Accordingly, when provided with a spinner 20 which effectively constitutes an axle 20 of rotation, a cellphone 12 may be lifted from tilting at rest on a supporting surface to spin well with minimal friction. However, the axle 20 must minimize friction and be pointed at an exact center in most events in order to spin well, smoothly, in a stable plane.

The system 10 may include various support connections 22. For example, a phone 12 may need a charger 22a or a charging jack 22a as well as an input/output (I/O) port 22b. Control buttons 14 will typically be positioned not on the face 24 or the front 24 of the housing, nor typically on the back 26 thereof. Rather around the rim 28 or edge 28 of the housing 12 may be placed most of the control buttons 14 audio connections 18, and other supporting connections 22.

The screen 30 on the face 24 will typically provide touch controls and the ability to present a keyboard, images, messages, texts, control dialog boxes, and so forth. Meanwhile, the back 26 typically only includes items such as the camera 16a, light 16b, and sensor 16d. Similarly, on the front 24 or face 24, in addition to the screen 30, another camera lens 16c and sensor 16d may position conveniently near a top end thereof (in a standing orientation). Since a phone 12 has a principal function acting as a phone, various speakers 18a, 18c may be provided on the face 24 or on the edge 18a.

A significant benefit of a balance sphere 20, of which only a small segment of the entire spherical surface is actually used, is an ability to balance the mass and angular momentum of the system 10 while spinning on a rigid, supporting surface such as a table, floor, counter, desk, or the like. Described hereinafter, the spherical nature of the spinner 20 or balance sphere 20 provides an uncanny ability to balance the system, even off center. It also provides a comparatively small (compared to a handle or entire case of a phone) contact surface, depending upon the rigidity, hardness, or both of both the balance sphere 20 and the underlying supporting surface. Theoretically, if each is infinitely hard then their contact will be a single point, infinitesimally small. In reality, all materials distort under load, and thus the balance sphere 20 and the underlying surface will contact at more than a single point. Nevertheless, by assuring the hardness and strength of the balance sphere 20 and the underlying surface, minimal frictional torque (force times radius at which acting) will engage the spinner 20 to slow the spinning of the system 10.

As a practical and very useful matter, the significance of spinning may be used as a truly random number generator. A random number may be generated by a time measured in seconds or fractions of a second. It may be a direction measured in angles, degrees of angle, radians, arc minutes or arc seconds, or the like. Likewise, rotation may be used in its totality, as some divided number thereof, or as a remainder after even division by a particular number.

For example, if one desires to pick one number out of four or one number out of ten, or one number out of any, 360 degrees of angle may be mapped to the numbered desired. Mapping may be thought of as associating one number at one maximum of each range with one another. Similarly, any number or range may be mapped to any other range by simply associating every point, end to end, or starting point to ending. The system does so mathematically by associating each extremum of a first range with the corresponding extrema of another range. Every point, regardless of how detailed or how small the subdivisions may be up to an infinite number of points, is associated between the two ranges. Thereby one may generate a random number and use it (map it) to provide (determine) any selection desired to be made.

For example, a circle may be divided into quadrants or eighths or any other subdivision. Meanwhile, that same circle may be divided into radians (pie per semicircle) degrees, arc minutes, and arc seconds. A spinning system 10 may traverse a full circle many times. Thus a very large number of potential values may be available at random. Alternatively, any rotation stopping at any orientation may thereby be used to pick any of the available arcuate values from a subdivided circle.

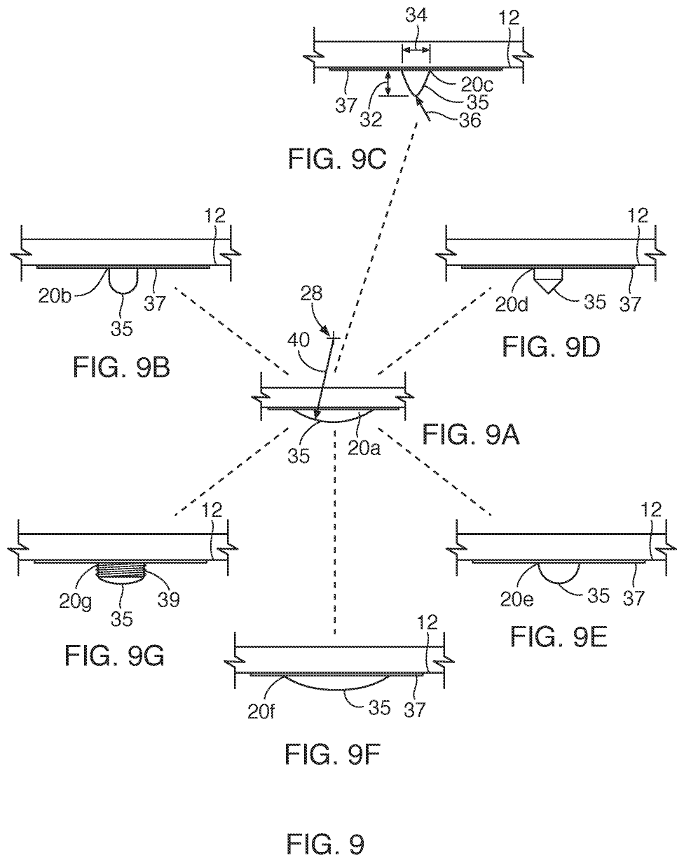

Referring to FIG. 9, which includes detailed, sub-images FIGS. 9A through 9G, a spinner 20 itself, here illustrated in various embodiments ranging from 20a through 20g may be characterized by a standoff distance 32 away from the housing 12, a diameter 34 of the structure constituting a base of a point 35, as well as a point radius 36 of the point 35 itself on a spinner 20. Typically, the point radius 36 helps define the maximum lever arm on which any contact of the point 35 with the underlying surface can act with frictional force to apply the torque that will reduce the time or attenuate the energy of rotation of the system 10 to an ultimate stop. Typically, a point 35 will be molded, cast, or otherwise fabricated integrally (as a solid, single unit, assembled or otherwise) or homogeneously (same material exactly, formed at the same time) with a base disc 37. The base disc 37 provides an ease of handling, ease of measuring, stability of mounting, and contact surface for adhesion with the housing 12 of the system 10. In this way, a point 35 may be precisely formed at a center of a base disc 37. In order that the point 35 may be precisely located at a center of mass, an axis through a center of mass of the system 10 is needed to coincide therewith.

In the embodiment of a spinner 20a, the spinner 20 is implemented as a balance sphere 20a. Accordingly, from some arc center 38 not necessarily within the segment of the balance sphere 20a that is actually formed and secured to the housing 12, a radius 40 is defined. It defines a mathematical hemisphere of which the balance sphere segment 20 is the useful physical portion.

One reason why the arc center 38 is not typically within the actual balance sphere spinner 20a, is self-balancing. A comparatively large (compared to the point 35) radius 40 is needed in order to provide many choices of contact, yet limit the standoff distance 32 of a surface 21 of the balance sphere 20a away from the housing 12 to which it secures.

It will be seen that a comparatively small nub 20b or hemisphere 20b on a pedestal, or as a pedestal 20b may be placed at the center of a base disc 37. Similarly, a comparatively sharp point 20c may be formed by molding it as part of a base disc 37, or as a projection 20c from that base disc.

As illustrated, a point 20d may actually have an underlying pedestal in order that the diameter of that pedestal may reflect the biggest diameter of the very point 35. Similarly, various sizes of hemispheres 20e may be used, but a comparatively large hemispherical frustum 20f is better. The embodiment of a sphere 20a forming only a small part of a hemisphere, with a comparatively medium sized footprint (of just less than half the width of a housing 12) has been found to work best.

By selecting a comparatively larger or smaller radius 40 for the hemisphere 20f, it will become the preferred embodiment of a balance sphere 20a. In fact, the balance sphere 20a may actually be attached to another handle 39, itself secured to the back face 26 or back 26 of the housing 12 as illustrated in FIGS. 2 and 4 hereinabove.

For example, a product called PopSocket™ provides a knob 39 that can selectively expand out (deploy) away from the back 26 of a housing 12. It provides space for fingers to secure therebetween the deployed knob 39 or handle 39. Thus, a user 15 may actually stack a non-deployed (collapsed) handle 39 under a balance sphere 20g to obtain the benefits of both. This has the effect of providing additional standoff height 32 between the back 26 of the housing 12 and a contact surface 21 of the balance sphere 20g illustrated.

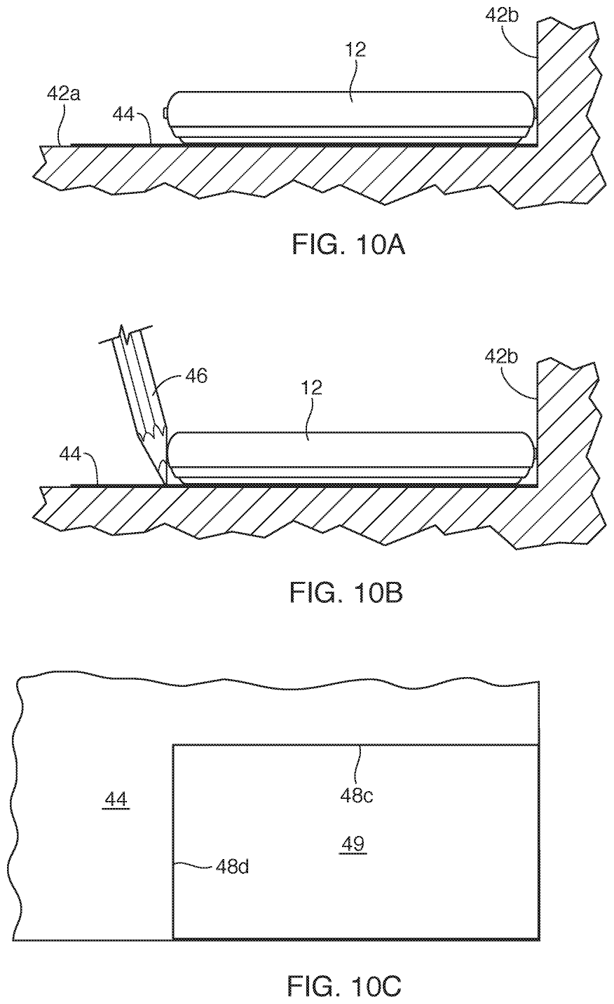

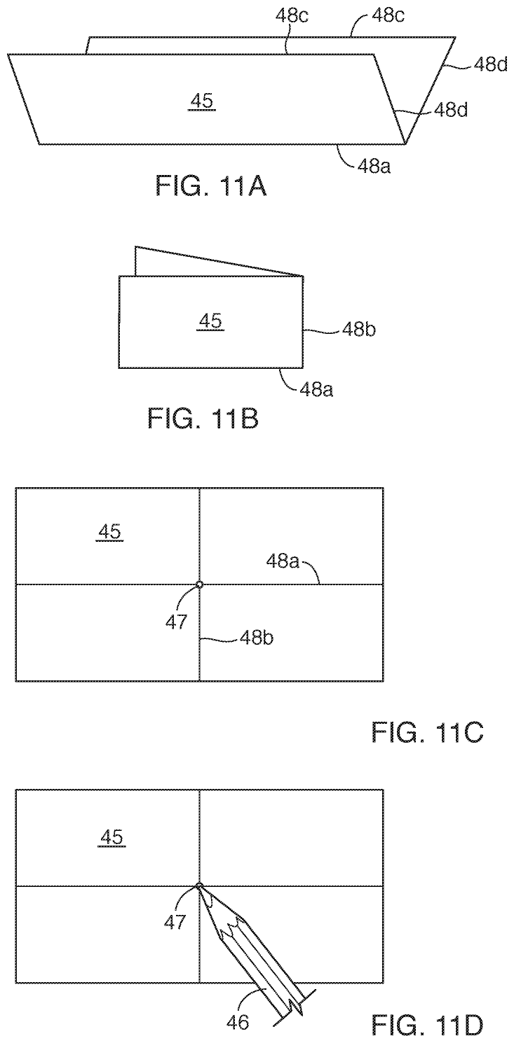

Referring to FIGS. 10A through 11D, certain embodiments of the spinners 20 (e.g., 20b-20d) require precise location of a spinning axis at a center of mass, which usually coincides to a centroid of area of a housing 12. To that end, one may set a system 10, and particularly the housing 12 or phone 12 thereof, on surfaces 42. For example, a horizontal surface 42a and a vertical surface 42b may be found in counter constructions in numerous places. If a paper 44 is set under the housing 12, and each is registered with (fitted against) the vertical surface 42b one may form a template 45.

For example, using a pencil 46 or other marker 46, one may draw the shape of the housing 12 on the paper 44 to form a template 45. By cutting out the template 45 from the paper 44, one may then locate a center 47 by forming a central intersection 47, and placing a pin hole 47 to represent that intersection 47.

This may be done quite straightforwardly by forming fold lines 48 in the template 45. For example, one may fold the template 45 along a longitudinal center line 48a, and then fold the template 45 across that fold line 48a to form a fold line 48b or lateral fold line 48b. Meanwhile, the edge 48c and the short edge 48d were already formed when the template 45 was cut from the paper 44.

The intersection 47 of the fold lines 48a and 48b may be provided with a pin hole 47 representing that intersection 47 of the fold lines 48a, 48b. Accordingly, one may then place the template 44 on top of the back 26 of the housing 12 with the housing 12 again face 24 down on the horizontal surface 42a and aligned (registered) against the vertical surface 42b.

By placing the open template 45 in alignment (registration) to exactly match the outline of the actual housing 12, one may mark through the pin hole 47 the intersection 47 of the fold lines 48a, 48b. Accordingly, the point 20 of a spinner 20, and particularly the base disc 37 thereof may then be positioned to put the point 35 exactly centered at the location of the marking of the pin hole 47.

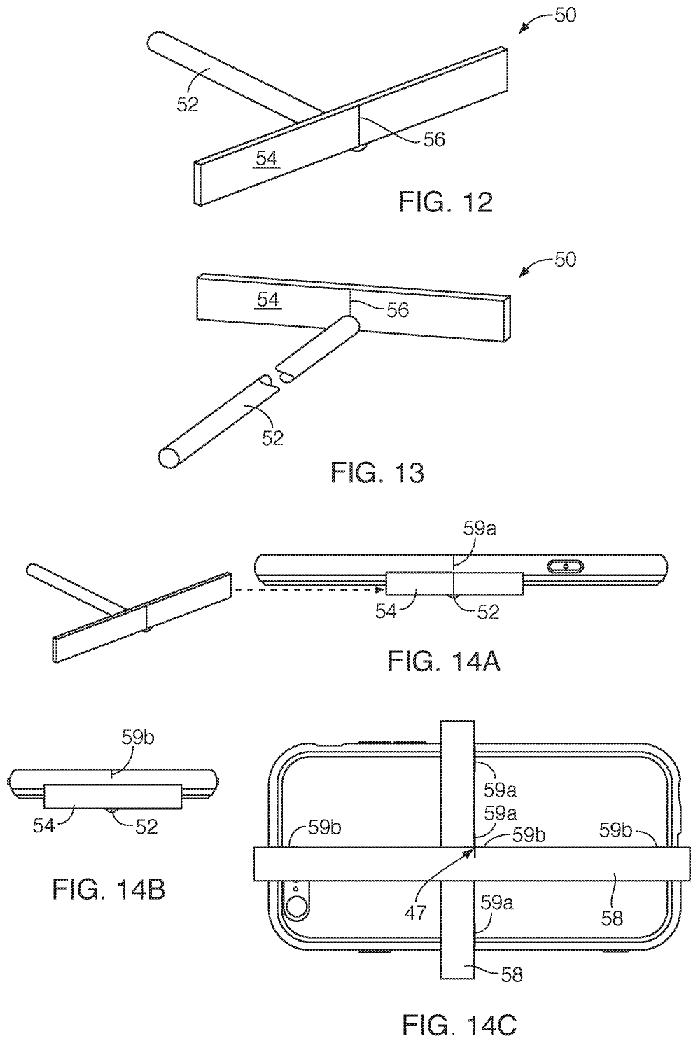

Referring to FIGS. 12 and 13, in another embodiment, an alignment may be done by using a roller square 50. A roller square 50 may operate much as a T-square would be used by a draftsman. For example, a roller 52 may roll with respect to a square 54. The square 54 extends at right angles to an axis of the roller 52 to maintain alignment of the housing 12 as it comes to balance on the roller 52.

In one currently contemplated embodiment, the roller 52 may be hollow, and an axle may extend from proximate a bottom edge of the square 54 in order to secure the roller 52 in rotational relation with respect to the square 54. Meanwhile, the square 54 has sufficient length to remain along an edge 28 of the housing 12 and in contact with a supporting surface therebelow.

Referring to FIGS. 14A through 14C, one may roll the housing 12 or phone 12 along the roller 52 while maintaining it in registration (alignment by contact against) the square 54. At the point at which the housing 12 and the entire system 10 balances on the roller 52, the exact center of mass longitudinally and laterally may be established. One may mark 56 or place a mark 56 as an indicator 56 on each end of a center line 56. This may be done in the longitudinal direction as well as the lateral directions. Accordingly, the marks 59a across the bottom 26 or back of the housing 12 establish a lateral balance line. Likewise, the marks 59b constitute a longitudinal center line 59b.

By application of a straight edge 58, sets of marks 59a, 59b may each, respectively, be connected as sets establishing an intersection 47 constituting a center with which the spinner 20, and more particularly the point 35 of a spinner 20 should be located on the back 26 of the housing 12.

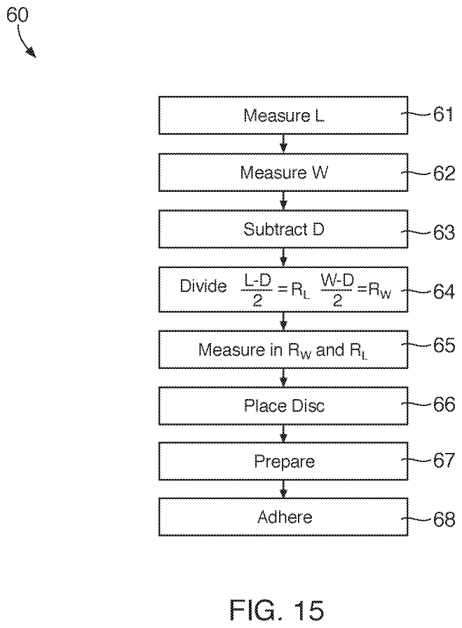

Referring to FIG. 15, yet a third method for orienting the point 35 or positioning of point 35 on the back 26 of the housing 12 is to actually measure 61 a length of the housing 12, and measure 62 a width thereof. From each of these values is subtracted 63 a diameter of the base disc 37. Lines thus measured and marked bound the left and right and top and bottom or longitudinal and lateral locations of the base disc 37 on the back 26 of the housing 12.

Dividing 64 the remaining distance or the difference between length and diameter and the difference between width and diameter, one may measure the exact position with respect to any edge 28 of the housing 12 a square defining the location of the base disc 37 inscribed therewithin. One may then place 66 the disc 37 within the measured boundaries, prepare 67 the surfaces, and adhere 68 the disc 37 bearing the point 35 thereon against the housing 12 precisely.

One benefit of the balance sphere 20a is that it provides balancing even if it is not precisely, or carefully positioned at the center of mass or center of area of the back 26 of the housing 12.

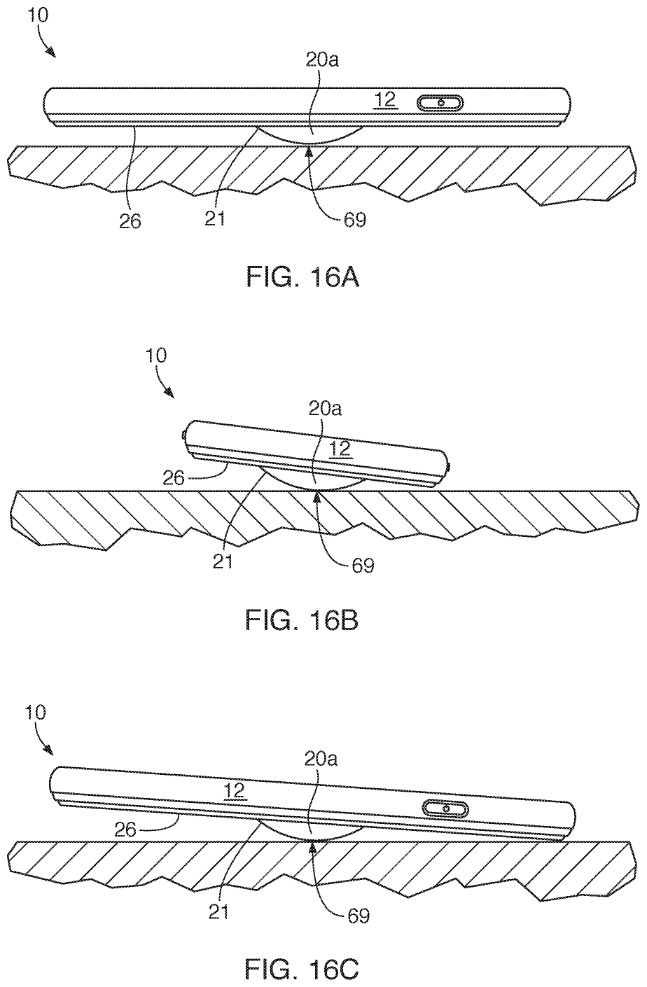

Referring to FIGS. 16A through 16C, a system 10 in accordance with the invention may be implemented by adhering a balance sphere 20a in a centered manner on a back surface 26 of a housing 12 of a system 10. Any of the foregoing methods may be used. However, it has been found that even securing the balance sphere 20 by simply dead reckoning and eyesight is typically sufficiently precise due to the nature of the balance sphere 20.

For example, if the balance sphere 20a is quite accurately centered to coincide with the axis constituting or passing through the center of mass of the housing 12, then the orientation of FIG. 16A is typical during spinning. A contact point 69 forms a centered balance point 35 coinciding with the geometrical center of the base disc 37 of the balance sphere 20a. Accordingly, the contact surface 21 is geometrically centered about the spinning point 35 at the contact point 69.

Referring to FIG. 16B, one sees the results of the balance sphere 20a being offset slightly to one side (laterally). In this case, the imbalance is cured by the balance sphere 20a pivoting (tilting) slightly to put the contact point 69 in the necessary location. In fact, upon beginning to spin the housing 12, the user 15 will note that the housing 12 will cant (tilt) in order to find a proper contact point 69 that will center the spinning about the centroid of mass or the line through the centroid of mass of the system 10.

Referring to FIG. 16C, in a similar fashion, a longitudinal error in centering the balance sphere 20a along the length of the housing 12 results in the housing 12 canting at an angle appropriate to balance the housing 12 and center the rotation in a flat spin at a contact point 69 that rectifies the error in positioning the balance sphere 20a.

Thus, it is called a balance sphere 20a type of spinner 20, because it self-balances the system 10 once installed. Of course, this balancing act or function has limitations. However, it has been found quite effective for rendering the system 10 capable of long spinning times through many degrees of angle and many rotations. Many housings 12 are treated with a silicone or other elastomeric coating that grips a surface. This renders the housing 12 incapable of spinning. Hard plastics may sometimes spin, but not well, and not reliably for generating large random numbers.

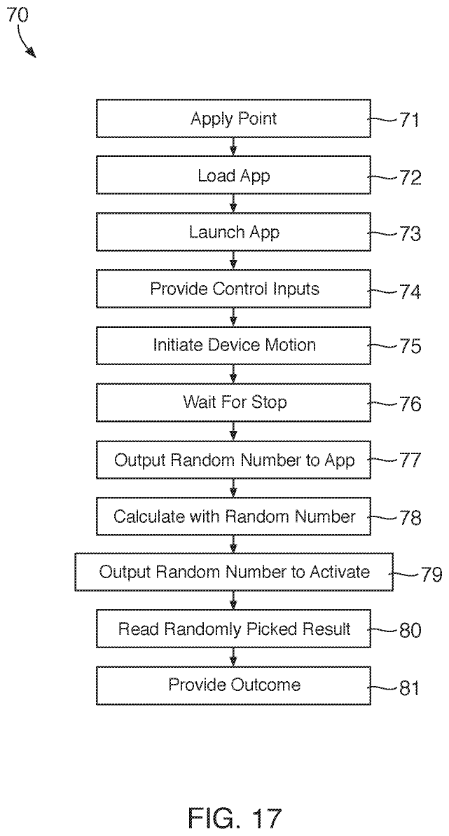

Referring to FIG. 17, a process 70 illustrates a mechanism for providing a random or randomly selected outcome. Initially, one may apply 71 a point 35 by applying 71 the base disc 37 centered about and containing the point 35, including the hereinabove described balance sphere 20a. One may load 72 an application or app into the computer system that constitutes a phone 12 and launch 73 the application.

Applications for which the system 10 is suitable will include any application that needs a random number or needs a chance event to start. A host of mathematical functions, passwords, cryptographic keys, parlor games, games of chance and strategy and the like benefit from having some chance event or random value provided.

A system 10 in accordance with the invention may provide this random or chance event, and any type of a value within any suitable range desired. For example, a system 10 may generate a binary decision between two choices. A system 10 may choose between three choices at random, or the like. Thus, as in the old “8-Ball™” toy, some polyhedron floated to a window at the top of the ball. According to which side of the polyhedron was oriented upward, that side would contact a window rendering readable certain writing on that face of the polyhedron. Such a game could be adapted to a phone 12 by relying on the random generation or chance calculations of a system 10 in accordance with the invention. Any game from the old game of yacht, spin-the-bottle, random predictive answering like the 8-Ball™ game, any card game, any card dealing or shuffling game, or the like can use the random value of orientation, elapsed time, or total included angle of rotation resulting from spinning. That value can be mapped to any value, such as combinations in dice, selection between a small (two to a dozen) choices, or used directly.

One may provide 74 any control inputs for the system 10. One may also need to provide 74 inputs for operating any application loaded 72, whether it be a scientific application 72 or an entertainment application 72. Accordingly, one may then initialize 75 or initiate 74 motion of the system 10 by spinning it on and about the point 35. One will typically need to wait 76 for the housing 12 to come to a stop.

At that point, the software has tracked the number of increments of elapsed time, angle units, or revolutions, totaling the spinning. It thereby can output 77 a value representing the spinning.

One may use any of several mechanisms to calculate 78 a desired decision that represents a choice based on the outcome of the physical rotation of the system 10. The system 10 includes a clock and angle tracking and orientation, detection and other measurements. One may read from the system 10 and particularly from a phone 12 any or all of those values. One may then output 77 that raw number.

Alternatively, that raw number may then be used to calculate by mapping as described hereinabove, by remaindering, by simply mapping onto a range from 0 to 1, 1 to 100, or any other range desired, a random number calculated 78 as desired. Any degree of precision capable of being tracked, will provide the only limit on the resolution. Any desired number of possible values may be candidates to be output 77, or calculated 78 based thereon.

At this point, the output 79 of the random number calculated 78 may then be read 80 by the subject application loaded 72. Accordingly, the application 72 then provides 81 an outcome, a decision based on the suitably random value calculated 78.

It can be seen that due to the virtual unpredictability of the number of physical revolutions, the exact number of degrees, minutes, or seconds of traversed angle, the amount of time subdivided into any number of increments from seconds, to milliseconds, microseconds, paraseconds, or the like may provide a desired randomness from each spinning event.

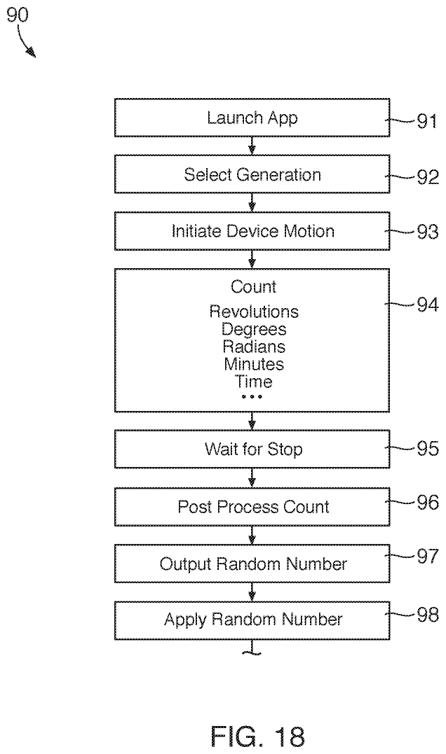

Referring to FIG. 18, another process 90 may include launching 91 a suitable application, and selecting 92 some mechanism for generation of a random number. That is, one may select what parameter is to be measured, how finely subdivided or incremented, and thereafter initiate 93 motion of the system 10. Again, parameters 94 may include a count of revolutions, degrees, radians, minutes, seconds, fractions of a second, decimal fractions of a second, (of angle or time) or the like.

Waiting 95 until spinning 75 stops results in a value that may be post processed 96. That is, counting 94 the parameter of interest or otherwise measuring 94 the parameter of interest, provides the input for post processing 96 that value 94 counted.

Again, outputting 97 the physically randomized number may then provide for applying 98 that number. This may be done by mapping in time, mapping in space, dividing to some portion, dividing out even divisions and thereafter working with a remainder, or the like. Combinations hereinabove may provide the decision 98 or the application 98 of the count 94 that is output 97.

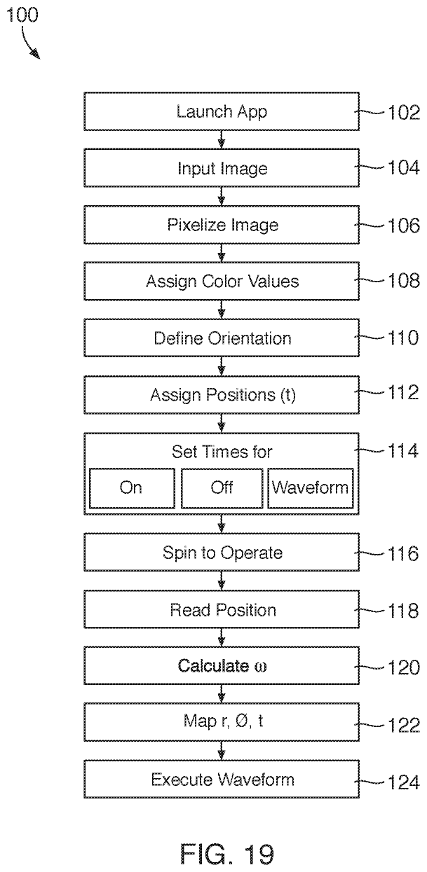

Referring to FIGS. 19 through 23, another interesting application that may be used or that may make use of the values tracked and accordingly output by the system 10. These may include angular velocities, and time predictions during the spinning 75, 93 of the system 10.

For example, in the illustrated embodiment, the process 100 may begin with launching 102 an application which will include inputting 104 an image for use by the application launched 102. The image input 104 may then be pixelized 106 and assigned 108 color values for each pixel. The image pixelized 106 may be static or dynamic. It may be still or a video. However, the processing speed of the system 10 will affect the ability to render a video image or a “still” on a spinning phone 12.

Nevertheless, by pixelizing 106 an image into some number of picture elements 106, and assigning 108 color values thereto (typically at least 256 values are available), the application 102 may then ask for an input 104 to define 110 an orientation desired for the image. One may do so by moving the system 10, stopping it, inputting a value or answering in a dialog box on a touch screen, or the like.

In the illustrated embodiment, the application 102 then assigns 112 positions as a function of time for each of the pixels. The apparatus then sets 114 times during which each pixel and each color on the screen 30 of the phone 12 will be on, off, and the wave form of its light signal meaning color and intensity.

Upon spinning 116 the phone 12, the system 10 then reads 118 a position, calculates an angular velocity, maps to a radius about the center of rotation and an angle at a time 122 a specific pixelization 106 or pixel 127 including a super pixel 126 in the image or mapped to the position of the screen 30. The application 102 then executes 124 a wave form for each actual pixel 126 on the screen 30 according to where the pixel 126 will be as a virtual pixel on the spinning phone 12.

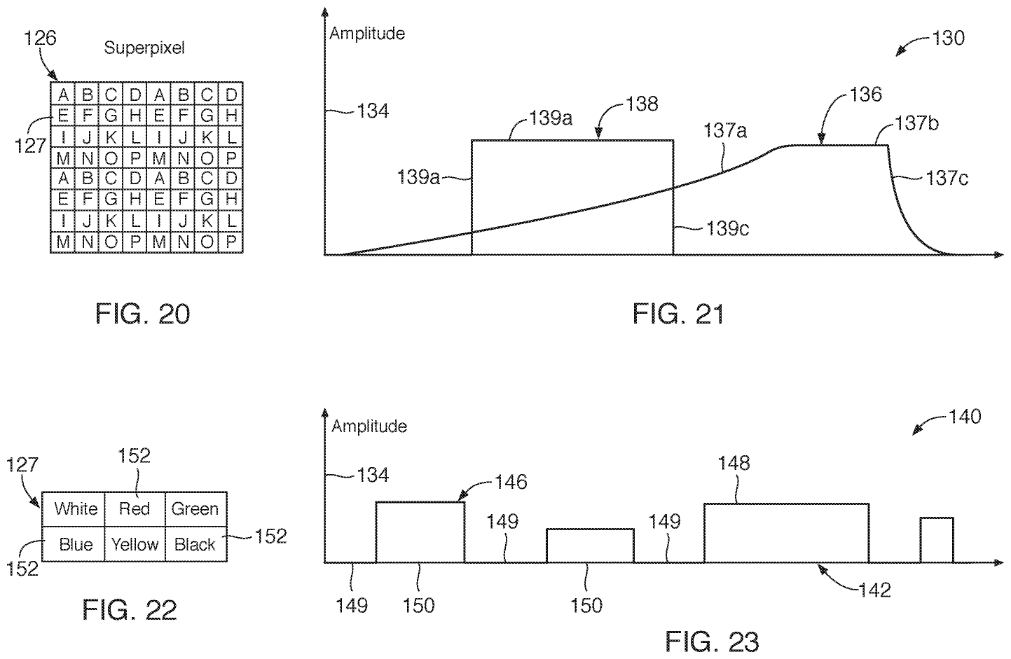

For example, referring to FIG. 20, the application 102 may operate using individual pixels 127 or super pixels 126 in which individual pixels 127 are assigned values, such as colors or intensities, and only one assignment for each pixel 127 exists in each super pixel 126. In FIG. 20, the grid represents four super pixels 126 in which each individual pixel 127 is labeled as one of letters A through P. In order to increase speed and minimize processing, an individual pixel 127 may have a responsibility for lighting at a certain time in a certain color to represent the entire super pixel 126 at that time and with that color.

Referring to FIG. 21, for example, a chart 130 of amplitude 134 of any individual pixel 127 as a function of time 132 is illustrated for both an analog wave form 136 showing the rise 137a, dwell 137b, and decay 137c of the amplitude 134. Similarly, a digital wave form 138 is shown wherein the rise 139a is comparatively steep, although it is not actually instant, but is simply much faster than the analog rise 137a.

Likewise, some dwell 139b is illustrated as well as a decay 139c, which looks very precipitous with respect to an analog wave form 136. By either mode, each individual pixel may be assigned a particular wave form 136, 138 to be executed in order to obtain the dwell 137b, 139b amplitude and time when it arrives at a specific location meaning angle, radius and so forth defining its position during the spinning of the system 10.

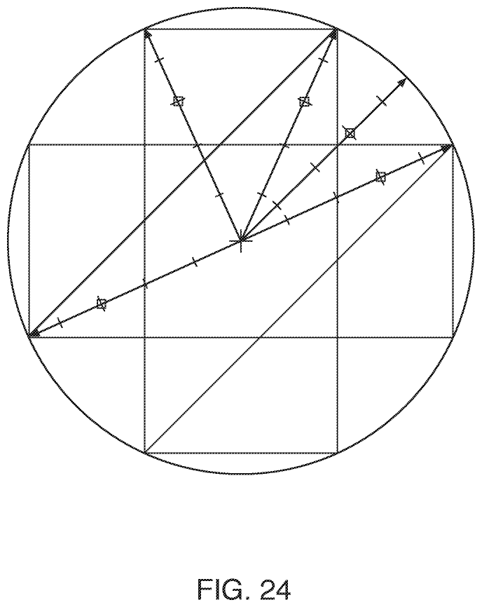

Referring to FIGS. 22 and 23, an alternative mechanism is to simply rely on the ability of an individual color in a pixel 127 to output white, red, green, blue, yellow, black, or whatever its particular color palette is. Accordingly, each pixel 127 or super pixel 126 may be assigned a digital wave form 148 constituted by “off” time 149 and “on” time 150. Each on time 150 represents a step 148 or a digital pulse 148 having some duration and amplitude. Thus, by mapping out the orientation of the image, each of the pixels 127 or super pixels 126 may simply have a wave form instructing that pixel what color to present at what time.

Since the retention of the human eye is about 1/16^{th} of a second, conventional cameras in filming movies operated at 24 frames per second. This provided for a smooth transition between frames, as far as the viewing eye was concerned. Accordingly, spinning will need to accommodate CPU clock time increments controlling electronics within the phone 12 driving the screen 30 in order to turn images on and off at their appropriate times as they reach their designated locations at which they are to represent an amplitude 134 of a color 152 of the screen 30 and thereby the image 104 thereof at that particular time.

In one embodiment, the instant invention may be implemented on the processor in any suitable electronic device, such as, for example, a smart phone. Thus, the application may rely on receiving for use any of several truly random numbers. These numbers will be physically random by virtue of a truly random, uncontrollable parameter associated with an event. Typically, spinning a phone, one may output for use a random time at which the device stops after initiating rotation or other motion (e.g. sliding, swinging, spinning, waving, tumbling onto a soft surface, bouncing, scribbling gestures, or any other motion event possible for a user to impart manually to the device).

Measurements output may reflect angular velocity at any chosen time demarcation, number of revolutions during a time period or after stopping, total included angle of rotation in degrees or radians in any number of spatial dimensions, angular orientation of the device upon stopping or at any time demarcation after “launch,” and so forth.

One may, for example, use Apple™ devices such as the Apple™ iPhone™ or a similar product equipped to spin on a surface, or simply toss the device into a soft target area, such as a foam pit (chunks of expanded elastomeric polymer), pillow, or the like. Such an implementation could be accomplished using the Swift programming language and Apple's “Core Motion Framework”, among other tools. Apple's “Core Motion Framework” provides developers with a rich set of software tools for managing Apple device's onboard sensors and the information these sensors are capable of providing. “CMMotionManager” is the object defined in Core Motion for managing Apple device motion services and the information available therein.

More particularly, the “CMMotionManager” object receives four types of motion data:

Accelerometer data, which includes the instantaneous acceleration of the device, such as an iPhone, in three dimensional space. This data includes measurements of increments of gravitational acceleration, i.e., 1 G-force=9.8 meters/second.

Gyroscope data, which includes the instantaneous rotation around the device's three primary axes. Measures rotational velocity in radians per second.

Magnetometer data, indicating the device's orientation relative to Earth's magnetic field. Device-motion data, indicating key motion-related attributes such as the device's user-initiated acceleration, its attitude, rotation rates, orientation relative to calibrated magnetic fields, and orientation relative to gravity. This data is provided by Core Motion's sensor fusion algorithms.

The processed device-motion data gives the device's attitude, rotation rate, calibrated magnetic fields, the direction of gravity, and the acceleration the user is imparting to the device.

The Apple developer documentation warns that only one CMMotionManager object should be created in any single application because multiple instances of this class can impact the rate at which data is received from the accelerometer and gyroscope.

The gyroscope, which measures the rate at which a device rotates around each of the three, orthogonal, spatial axes, provides the data upon which the present invention may be implemented. Most iOS devices have a three-axis gyroscope, which delivers rotation values in each of the three spatial axes. Rotation values are measured in radians per second around the given axis. Rotation values may be positive or negative depending on the direction of rotation.

Gyroscope data can be accessed using the classes of the Core Motion framework. Specifically, the CMMotionManager class provides the interfaces for enabling the gyroscope hardware. Before enabling that hardware, one needs to always check the value of the “isGyroAvailable” property to verify that the gyroscopes are available for use. Once the gyroscope is enabled, several interface options are available for receiving the gyroscope data.

The gyroscope data can be “pulled” as needed, or the framework can be configured to “push” updates to an app at regular intervals. Each technique involves different configuration steps and has a different use case. Also, the raw rotation rate data delivered by the gyroscope interfaces may be biased by other factors such as device acceleration. The present invention can be implemented using either raw gyroscope data or processed, unbiased data, which is available through the device-motion interfaces instead. The device-motion interfaces use special algorithms to remove any bias and deliver more precise rotation values.

A code snippet immediately below provides an example of Apple Swift code in which a CMMotionManager object is created and assigned to a constant called “motion.” The remainder of the code snippet provides an example of code. All of the sensors and their output values may be accessed using steps analogous to the following, which capture motion data from onboard sensors, a gyroscope in this example:

Check for presence of a functioning gyroscope on the device;
Set sample interval on the gyroscope;
Set motion sample timer;
Initiate motion data stream from sensor (e.g., gyroscope in example);
//(or accelerometer, magnetometer, compass, altimeter, etc.) ;
Receive and store output data while timer runs;
//(gyroscope: angular acceleration, velocity, or position;
//magnetometer: position with respect to earth's magnetic field;
//accelerometer: acceleration, or integrated to velocity, position, or
distance;
//altimeter :relative altitude change
When timer finishes, deactivate sensor (e.g., gyroscope).

Example code may look like this:

let motion = CMMotionManager( ) // Create and assign

CMMotionManager object to constant designated as “motion”

func startGyros( ) { // Function that starts gyroscope, if available
if motion.isGyroAvailable { // Check if functioning gyroscope is present
self.motion.gyroUpdateInterval = 1.0 / 60.0 // If so, set sample interval at
60 samples/sec
self.motion.startGyroUpdates( ) // Start receiving and storing gyroscope
motion data
// Configure a timer to fetch the motion data.
self.timer = Timer(fire: Date( ), interval: (1.0/60.0),
repeats: true, block: { (timer) in
// Get the gyro data assigning the data to constants “data”, “x”, “y”, and
“z”.
if let data = self.motion.gyroData {
let x = data.rotationRate.x
let y = data.rotationRate.y
let z = data.rotationRate.z
// Use the gyroscope data in the app.
}
})
// Add the timer to the current run loop.
RunLoop.current.add(self.timer!, forMode: .defaultRunLoopMode)
}
}
func stopGyros( ) {
if self.timer != nil {
self.timer?.invalidate( )
self.timer = nil
self.motion.stopGyroUpdates( )
}
}
func startAccelerometers( ) {
// Make sure the accelerometer hardware is available.
if self.motion.isAccelerometerAvailable {
self.motion.accelerometerUpdateInterval = 1.0 / 60.0 // 60 Hz
self.motion.startAccelerometerUpdates( )
// Configure a timer to fetch the data.
self.timer = Timer(fire: Date( ), interval: (1.0/60.0),
repeats: true, block: { (timer) in
// Get the accelerometer data.
if let data = self.motion.accelerometerData {
let x = data.acceleration.x
let y = data.acceleration.y
let z = data.acceleration.z
// Use the accelerometer data in your app.
}
})
// Add the timer to the current run loop.
RunLoop.current.add(self.timer!, forMode: .defaultRunLoopMode)
}
}

In certain alternative embodiments, one may rely on parameters measured through touch or gesture recognition by the device. For example, one may scribble a random gesture, which may then be interpreted for its length, time duration, distance between endpoints, number or directional reversals or other changes, or other customized parameter measurable with respect to the gesture.

UITouch is an object representing the location, size, movement, and force of a touch occurring on the screen. Touch objects can be accessed through UIEvent objects passed into responder objects for event handling. A touch object includes accessors for: 1) The view or window in which the touch occurred; 2) The location of the touch within the view or window; 3) The approximate radius of the touch; 4) The force of the touch (on devices that support 3D Touch or Apple Pencil). A touch object also contains a timestamp indicating when the touch occurred, an integer representing the number of times the user tapped the screen, and the phase of the touch in the form of a constant that describes whether the touch began, moved, or ended, or whether the system canceled the touch.

A touch object persists throughout a multi-touch sequence. A reference to a touch may be stored while handling a multi-touch sequence so long as that reference is released when the sequence ends. If a need to store information about a touch outside of a multi-touch sequence arises, copy that information from the touch. The gestureRecognizers property of a touch contains the gesture recognizers currently handling the touch. Each gesture recognizer is an instance of a concrete subclass of UIGestureRecognizer.

Parameters measurable may include a tap count, timestamp, view and window the touch occurred in, major radius and minor radius, states, like a “began phase,” moved phase, lift, ended phase, and so forth.

UIPanGestureRecognizer Properties and Methods may provide extra properties. These may be accessed by an object UIGestureRecognizerState that tracks the state, numberOfTouches that counts touches and type, how many fingers are touching, the locationInView, a pan gesture recognizer, a velocityInView, translationInView for movement along the screen, beyond what is basically available with UITouch and UIEvent

Touch-Event cycle with a Gesture Recognizer may use the initWithTarget action initializer similarly to a UIButton, which uses similar concept. It can provide velocity and other data not available in a normal touch event code. Gesture recognizers in an imageView with the userinteractionEnabled being set to no accepts (receives) no touches. Rotation gestures, as well as simultaneous gestures may be used as inputs using Xcode in a PhotoTouch mode where multiple gesture recognizers operate at once, such as a panGesture, pinchGesture, or Rotation gesture.

The present invention may be embodied in other specific forms without departing from its purposes, functions, structures, or operational characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A method for generating a random number, the method comprising:
providing a spinner capable of contacting a surface, spinning thereupon, and supporting a mass thereabove;
providing, as the mass, an apparatus capable of spinning for an unpredictable time on the surface, supported by the spinner;
providing a processor in the apparatus, operably connected to a non-transitory, computer-readable memory and programmable to read therefrom and execute an application capable of detecting a measurement reflecting the spinning; and
generating, by the processor a random number based on the measurement.

2. The method of claim 1, comprising detecting at least one of degrees, angular arc minutes, angular arc seconds, radians, revolutions, time in seconds, and time in subdivisions of seconds corresponding to a duration of the spinning condition.

3. The method of claim 2, comprising detecting a direction of orientation of the apparatus upon cessation of the spinning.

4. The method of claim 3, comprising outputting a value of the measurement as a random number reflecting a physical event of spinning.

5. The method of claim 5, comprising executing, by the processor, an assignment application assigning a meaning based on the random number.

6. The method of claim 5, wherein the meaning is selected from a selection of a person, a selection of one of a plurality of pre-determined answers to a question, selection of a lesser number corresponding to a range within which the random number falls, a direction, and an instruction selected based on the random number.

7. The method of claim 6, comprising launching a tracking application on the processor capable of measuring a parameter characterizing the spinning.

8. The method of claim 7, wherein the parameter is selected from a duration of time, a total included angle of rotation, a difference between an angle of orientation of the apparatus before the spinning and after the spinning, a mapping onto a fixed interval one of the forgoing, and a calculation based on a combination of two or more thereof.

9. The method of claim 8, comprising providing to the CPU and executing thereon a meaning application providing a sensible output understandable to a human based on the parameter.

10. The method of claim 9, wherein the sensible output is a controller of a decision.

11. An apparatus comprising:
a device comprising a central processing unit (CPU), a computer readable, non-transitory, memory device operably connected thereto, and a housing containing both and capable of rotation in a plane parallel to a plane of maximum moment of inertia of the apparatus;
a post, functional as a pivot, located near a center of mass of the apparatus, being secured to the housing and shaped to reduce a moment arm of friction acting on the device when positioned on a rigid surface;
the memory device containing a first executable loadable into the CPU and capable of programming the CPU to track rotation of the apparatus about the post and to output a random number based on the rotation; and
the memory device containing a second executable programmable into the CPU to effectuate an output as a function of the random number.

12. The apparatus of claim 11, comprising a fastener capable of securing the post to the housing.

13. The apparatus of claim 12, wherein the post is shaped to present a rounded surface in contact with the supporting surface.

14. The apparatus of claim 13, wherein the rounded surface is a portion of a sphere.

15. The apparatus of claim 13, wherein the post comprises a standoff spacing the rounded surface away from the housing.

16. The apparatus of claim 13, wherein the housing comprises a flat surface against which the post is secured.

17. The apparatus of claim 11, wherein the housing contains telephonic capability.

18. The apparatus of claim 17 wherein the apparatus includes a mobile telephone.

19. The apparatus of claim 11, comprising a kit containing the post separate from the housing and instructions for mounting the post to the housing.

20. A method comprising:
providing a spinner capable of contacting a surface, spinning thereupon, and supporting a mass thereabove, the mass including a non-transitory, computer-readable memory and a processor, operably connected to store and execute, respectfully, an application capable of detecting a measurement reflecting spinning of the mass for an unpredictable time on the surface;
executing on the processor a meaning application capable of making a decision based on a random number;
executing on the processor a tracking application capable of detecting a duration of spinning of the mass by measuring at least one of degrees, arc minutes, arc seconds, radians, revolutions, time in seconds, time in subdivisions of seconds corresponding to the duration, and
a direction of orientation of the apparatus upon cessation of the spinning; spinning the mass on the spinner;
measuring a parameter characterizing the spinning and selected from a duration of time, a total included angle of rotation, a difference between an angle of orientation of the apparatus before the spinning and after the spinning, a mapping onto a fixed interval one of the forgoing, and a calculation based on a combination of two or more thereof;
outputting a random number based on the parameter; and
executing, by the processor, an assignment application assigning a meaning based on the random number, wherein the meaning is selected from a selection of a person, a selection of one of a plurality of pre-determined answers to a question, selection of a lesser number corresponding to a range within which the random number falls, a direction, and an instruction selected based on the random number.
